(19) United States
(12) Patent Application Publication
(10) Pub. No.: US 2010/0215300 A1
(43) Pub. Date: Aug. 26, 2010

(54) THRUST WASHER AND RADIAL-AXIAL BEARING HAVING SUCH A THRUST WASHER

(76) Inventor: Norman Schlabs, Taunusstein (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/678,220

(22) PCT Filed: Sep. 12, 2008
(86) PCT No.: PCT/EP08/62191

§ 371 Date: Mar. 15, 2010

(30) Foreign Application Priority Data
Sep. 13, 2007 (DE) 10 2007 044 850.5

(51) Int. Cl. F16C 17/04

(52) U.S. Cl. 384/420

(57) ABSTRACT

The invention relates to a thrust washer and to a radial-axial bearing having such a thrust washer. The thrust washer is configured as a semicircular flange ring having three connection tabs, which are disposed spaced apart in the peripheral direction on the radially inner edge of said ring and are directed radially inward, for the positive connection to a radial bearing part. At lest the outer connection tabs in the peripheral direction have inner edges facing the centerline of the thrust washer, which do not form any undercuts in relation to a feed direction parallel to the centerline. The router connection tabs in the peripheral direction have outer edges facing away from the centerline, which run radially.

The invention relates to a thrust washer in the form of a semi-circular flange ring with at least two, preferably at least three connection plates directed radially inwards, located spaced at its radially inner edge in the circumferential direction for the positive connection with a radial bearing part as well as a radial-axial bearing with a radial bearing part and a thrust washer of the aforementioned type connected with this.

Radial-axial bearings are used, for example, in engine construction as crankshaft bearings or the like. The radial bearing part can be designed as a semi-cylindrical bearing shell or as a bushing. Basically two construction forms are known for the connection of the thrust washer(s) with the radial bearing part. In the case of the so-called constructed bearings the radial bearing part and the thrust washer are latched positively and undetachably with each other by means of appropriately shaped plates at the thrust washer and corresponding retaining openings at the radial bearing part. Embodiments of such constructed bearings are known, for example, from DE 33 45 652 A1 or DE 41 40 277 A1. The assembly of the bearings requires a special tool or a specially equipped automatic assembly machine due to the complex feed and latching movement or due to additional work steps, in which the plates are caulked after the components are brought together. The assembly is therefore not uncommonly carried out through manual intervention. Furthermore, the connection plates and/or retaining openings have geometries which are complicated and thus expensive with regard to manufacturing, which provide for a secure connection between both of the components in the latched state.

In the second construction form the radial-axial bearings are welded with each other. In this construction form the radial bearing part has recesses on the face side, in which the connection plates of the thrust washer are inserted in the axial feed direction.

As a rule, a bearing half-shell has a spread angle, i.e., its basic shape in contrast to the thrust washer is not semi-circular. The spread angle is nullified with the installation of the half bearing in the bearing seat of the bearing housing or cap provided therefor. Beforehand, however, the spread angle must also at least in part be nullified with the assembly of the bearing shell with the thrust washer, until the connection plate and the recesses align.

Since the thrust washer and the bearing half-shell in this construction form are not undetachably connected with each other after being combined, they are connected after being combined at one or more locations of the outer circumference of the bearing half-shell on the face side by welding. By way of example, reference is made to DE-OS 25 28 576 A1, DE-OS 24 12 870 A1 (the latter without explicit reference to a welded joint) or WO 2005/090803 A1. WO 2005/090803 A1 teaches for example, a shoulder directed radially inwards to provide for welding of the thrust washer with the radial bearing part at the radial inner edge of the thrust washer, in which the welded joint is designed as a predetermined breaking point, which breaks open in the intended use of the radial-axial bearing. It is disadvantageous, that in all these cases a special assembling device is needed, which provides for a despreading of the bearing half-shell, and a special automatic assembly machine equipped for the axial feeding of the thrust washer is required.

Furthermore, for example, bearing shells are known from GB 2 225 392 A, which provides for a connection plate, which is located offset in the circumferential direction to a center line of the thrust washer, in order to exclude a inadvertently false orientation of the thrust washer during the assembly with the radial bearing part.

In the aforementioned prior art of welded radial-axial bearings all connection plates are directed radially inwards in such a way that their inner and outer edges in the circumferential direction run approximately radially. Through this at least the outer connection plates in the circumferential direction form undercuts with regard to a direction parallel to the center line of the thrust washer. This brings it about, that the thrust washer can only be assembled in the feed direction with the radial bearing part. At variance with this a flanged bearing shell with a thrust washer is known, for example, from DE 198 25 117 A1, whose outer connection plates are arranged parallel to the center line of the thrust washer and which engage with the corresponding retaining openings of the radial bearing part. More precisely, both the edges facing the center line as well as the edges turned away from the center line run parallel to the center line. This permits a radial feeding of the thrust washer for the assembly of the radial-axial bearing.

Based on this prior art it is the task of the present invention to further improve the geometry of the thrust washer to the effect, that in a simple manner an improved positive form locking and an improved torsional support of the thrust washer against the radial bearing part is ensured.

The task is solved by a thrust washer according to patent claim 1 and by a radial-axial bearing according to patent claim 7.

The thrust washer according to the present invention is further developed in that the outer connection plates in the circumferential direction have edges turned away from the center line (outer edges), which run radially.

The edges of the outer connection plate facing the imaginary center line of the thrust washer (inner edge) nevertheless do not form any undercuts with regard to a feed direction parallel to the center line.

This implies connection plates with geometries, with which the edges facing the center line run preferably parallel to the center line, are chamfered or are beveled outwards. What is decisive here is that fact that the edges of the connection plates facing the center line have no undercuts with regard to the center line and thus to a radial feed direction along the center line. Through this it is made possible to feed the thrust washer radially during the assembly with the radial bearing part. This movement can be implemented easier automatically. The plates are thus inserted into the corresponding retaining openings of the radial bearing part perpendicular to the bearing shaft without latching and the bearing half-shell must not be despread for this purpose.

The plate geometry according to the present invention permits a plane front face of the radial bearing part without recesses on the face side, since the thrust washer with its connection plates can also be inserted radially from outside into slit-shaped retaining openings in the lateral area of the radial bearing part. The position of the thrust washer relative to the radial bearing part in the case of slit-shaped retaining openings is also in the axial direction and thus completely defined. A precise positioning and fixation of both components is therefore also assured without a special assembling device.

The geometry of the outer edge ensures, that the thrust washer over the outer edges of the connection plates in the installed condition of the bearing lies positively and flatly against the corresponding outer lateral edge of the retaining openings. Through this the thrust washer is supported during the rotary motion of the counter-rotor in the one as well as in the other direction in each case over one of the two outer edges against the radial bearing part. The advantageous traction in the case of this geometry of the outer edge is also ensured, when the corresponding retaining opening in the radial bearing part is punched out radially. Unlike the retaining openings known from DE 198 25 117 A1, which have side walls parallel to the joint direction, retaining openings with side walls running radially are comparatively simple with regard to manufacturing and in particular can also still be inserted by die cutting in angular ranges lying far outside of the bearing shell. Connections between the thrust washer and the radial bearing part, which lie far outside and thus further apart from each other improve the positive support.

Preferably a middle connection plate is provided, which is located offset in the circumferential direction to the center line.

Through the asymmetrical arrangement and a corresponding asymmetrical alignment of the corresponding retaining openings in the radial bearing part the orientation of the thrust washer is distinctively defined relative to the radial bearing part. Through this measure, for example, both a mix-up of the thrust washers as well as an inadvertently false orientation of the thrust washer during the assembly are excluded.

For the reasons previously presented, preferably the edge of the middle connection plate facing the center line of the thrust washer also forms no undercuts and runs particularly preferably parallel to the center line.

If the offset of the middle connection plate to the center line is smaller than half the width of the plate, there is strictly speaking no edge facing the center line. In this case, that edge of the middle connection plate, which is nearer to the center line, is to be understood by the facing edge.

Furthermore, in each case a front face of the outer connection plate connecting the inner edge with the outer edge is preferably arranged essentially tangentially.

This tangential front face facilitates the threading of the connection plates of the thrust washer into the retaining openings of the radial bearing part during the assembly, particularly, when the bearing shell has a spread angle.

According to an advantageous further development of the radial-axial bearing the thrust washer is connected with the radial bearing part by means of a welded joint. The welded joint is preferably effected by laser welding or by spot welding. This welded joint is designed particularly preferably as a predetermined breaking point, which breaks during introduction of a defined tangential force.

The welded joint thus serves as a temporary connection for the transport and for the simplification of the assembly. For the compensation of tolerance-related imprecisions of the bearing housing or the counter-rotor a slight axial and radial play between the thrust washer and the radial bearing part is desirable. Therefore, the rigid welded joint should break open in operation and the axial bearing part (the thrust washer) and the radial bearing part should be released for a relative movement. The welding parameters are therefore to be set up, so that the welded joint does not resist the forces exerted by the torque during the start-up of the counter-rotor (the crankshaft or the like) on the welded joint in the tangential direction. A design of the welded joint is to be determined depending on application, bearing size, area of contact between counter-rotor and thrust washer, composite materials (bearing material and counter-rotor), etc.

Preferably the thrust washer is welded with the radial bearing part in the apex area and particularly preferably at a shoulder directed radially inwards, located at its inner radial edge.

In the case of despreading the ends of the bearing shell are pressed together in the circumferential direction. In the process, a relative movement of the bearing shell to the thrust washer occurs in these end areas, whereas the apex area remains neutral as a center of symmetry, thus effects no relative movement. Therefore, the welded point is preferably located here.

Further tasks, characteristics and advantages of the invention are elucidated in detail below by means of an execution example with the aid of drawings:

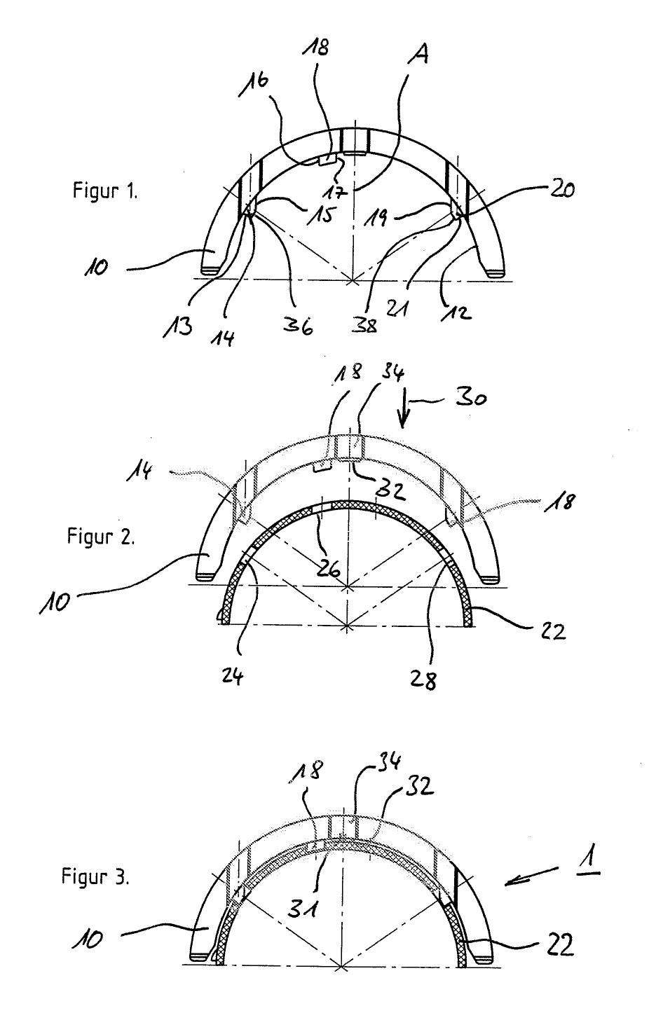

FIG. 1 shows an execution example of the thrust washer according to the present invention;

FIG. 2 shows the thrust washer according to FIG. 1 during the joining with a corresponding radial bearing part and

FIG. 3 shows the connected radial-axial half-bearing.

The thrust washer 10 has the form of a semi-circular ring and has at its radial inner edge 12 three connection plates 14, 18 and 20 located spaced in the circumferential direction and directed radially inwards. The outer connection plates 14 and 20 in the circumferential direction have in each case edges facing the imaginary center line “A” or inner edges (strictly speaking these are areas) 15 or 19, which run parallel to any center line A. The middle connection plate 18 is located offset to the center line A. From this an asymmetry results, which as shown in FIG. 2 excludes a mix-up or rotation of the thrust washers during assembly with the radial bearing part 20. Also the middle connection plate has an edge 17 facing the center line A, which runs parallel to that center line A. Also, this edge thus forms no undercut in regard to the feed direction 30 parallel to the center line A.

The installation situation is represented schematically in FIG. 2. The thrust washer is fed radial to a radial bearing element in the form of a bearing half-shell 20, i.e. precisely parallel to the center line A. No edge of the three connection plates 14, 18, 20, particularly no edges facing the center line A form an undercut with regard to the feed direction 30. Therefore, the plates can be inserted without latching and thus without overcoming a stop in corresponding retaining openings 24, 26 and 28 of the bearing half-shell 22. In the process, particularly the inner edges 15 and 19 parallel to the center line A in the illustrated execution example form leading edges in an advantageous manner. Hence, the bearing half-shell 22 must not be despread for the assembly of the thrust washer 10—a spread angle is not depicted in the figures for purposes of simplification.

In the assembled state according to FIG. 3 the thrust washer 10 is fixed by means of a welded joint 31 as much as possible in the area of the center line A to the bearing half-shell 22 for the transport and the assembly of the radial-axial bearing. More precisely, this is done by a shoulder 32, which is carved out of the steel of the thrust washer and which is welded, preferably on the face side, with the outer circumferential steel upper surface (not explicitly depicted) of the bearing half-shell. Since the bearing shell on the face side usually has a running surface made of a sliding layer or bearing layer material of another composition, which as rule is not suitable for welding, this layer material is removed in the area of the shoulder. This has taken place in the execution example in the form of a cleared groove 34.

It can basically remain open as to whether the retaining openings 24, 26, 28 in the bearing half-shell 22 are designed in the form of open recesses on the face side or in the form of slits bordered on all sides.

The geometry and dimensions of the connection plates 14, 18, 20 and the retaining openings 24, 26, 28 is also selected, so that the thrust washer, particularly in operation, is supported in every rotational direction in each case with an outer edge 13, 21 of the outer connection plates 14, 20 as well as with a similarly oriented edge 16, 17 of the middle connection plate 18 against the in each case corresponding lateral edges of the retaining openings (torsional support).

Thereby, the areas of the outer edges 13 and 21 running radially inwards and the areas of the edges 16 and 17 running approximately radially inwards lie flat against the dedicated areas of the lateral edges of the retaining openings and form the best possible positive form locking for the introduction of the forces operating in the circumferential direction. At the same time the thus shaped retaining openings are radially punched out in a simple manner with regard to manufacturing, even if they are located very far outside, for example, in the angular ranges greater than or equal to 25°, preferably greater than or equal to 30° or also greater than or equal to 35° with regard to the center line A. This geometry again improves the torsional support.

Both of the connection plates 14 and 18 also have in each case a front face 36 or 38 connecting their upper inner edge 15 or 19 with their outer edge 13 or 21. This runs essentially tangential to an imaginary circle about the center point of the thrust washer 10. The bevel formed by the tangential front face (in reference to the feed direction 33) permits a facilitated threading of the plates into the corresponding retaining openings 24 or 22 during the assembly also without despreading of the radial bearing part 22.

It is immediately evident, that at least three connection plates prove to be advantageous. In the case of only two connection plates (or merely one) at least in the rotational direction only one edge serves for torsional support, which then forms a pivotal point, around which undesirable breakdown torques can arise. This effect and abrasive wear connected with it does not arise in the case of two contact edges spaced in the circumferential direction.

Instead of the three connection plates depicted in the execution example the trust washer according to the present invention can get by on two connection plates, of which at least one connection plate is not located in the center of the center line and has an edge facing the latter, which forms no undercuts. Also, four or more connection plates are possible, provide a correspondingly increased number of edges for the torsional support.

Instead of the bearing half-shell selected in the execution example the thrust washer according to the present invention can be attached in a similar manner also to a bushing. Preferably, in the case of such a radial-axial bearing two thrust washers would be assembled with the bushing from two radially opposed directions in the manner described, in order to form a comprehensive axial bearing ring.

### REFERENCE NUMBER LIST

1 radial-axial-bearing
10 thrust washer
12 radial inner edge
13 outer edge
14 outer connection plate
15 edge facing the center line
16 outer edge
17 edge facing the center line
18 middle connection plate
19 edge facing the center line
20 outer connection plate
21 outer edge
22 semi-cylindrical bearing shell
24 retaining opening
26 retaining opening
28 retaining opening
30 feed direction (arrow)
31 welded joint
32 shoulder
34 groove
36 front face
38 front face

1. Thrust washer comprising a semi-circular flange ring with at least two outer connection plates directed radially inwards, located spaced at a radially inner edge in the circumferential direction for the positive connection with a radial bearing part, in which said at least two outer connection plates in the circumferential direction have inner edges facing the center line of the thrust washer, which form no undercuts with regard to a feed direction parallel to the center line, and wherein said outer connection plates have outer edges turned away from the center line, and which run radially.

2. Thrust washer according to claim 1, wherein said inner edges facing the center line of the thrust washer run parallel to the center line.

3. Thrust washer according to claim 1 wherein, a middle connection plate is provided which is offset in the circumferential direction to the center line.

4. Thrust washer according to claim 3, wherein said inner edge of the middle connection plate facing the center line of the thrust washer forms no undercuts.

5. Thrust washer according to claim 1, wherein, a shoulder directed radially inwards, located at a radial inner edge thereof for welding with the radial bearing part.

6. Thrust washer according to claim 1, wherein in each case a front face of the outer connection plates connecting the inner edge with the outer edge is arranged essentially tangentially.

7. A thrust bearing assembly comprising a radial bearing part and a thrust washer connected with the radial bearing part, said thrust washer comprising claim 1.

8. The assembly of claim 7, wherein the thrust washer is connected with the radial bearing part by means of a welded joint.

9. The assembly of claim 8, wherein the welded joint defines a predetermined breaking point, which breaks during the introduction of a defined tangential force.

10. The assembly of claim 8, wherein the thrust washer is welded with the radial bearing part in the apex area.

11. The assembly of claim 8, wherein the thrust washer is welded at a shoulder of the thrust washer with the radial bearing part.
